(19) United States
(12) Patent Application Publication
(10) Pub. No.: US 2008/0285397 A1
(43) Pub. Date: Nov. 20, 2008

(54) METHOD AND DEVICE FOR READING INFORMATION RECORDED IN A BOUNDARY AREA ON AN OPTICAL DISC

(76) Inventors: Te-Wang Tseng, Hsinchu County (TW); You-Kuo Lin, Tai-Nan City (TW); Kun-Feng Lin, Tai-Nan City (TW)

Correspondence Address: NORTH AMERICA INTELLECTUAL PROPERTY CORPORATION, P.O. BOX 506, MERRIFIELD, VA, 22116, US

(21) Appl. No.: 11/749,758

(22) Filed: May 17, 2007

(51) Int. Cl. G11B 7/00; G11B 19/04; G11B 7/085

(52) U.S. Cl. 369/44.28; 369/53.24

(57) ABSTRACT

The present invention provides a method for reading information recorded in a boundary area adjacent to a boundary between a first area and a second area on an optical disc. The method includes: controlling a pick-up head (PUH) to detect the optical disc to generate a detection signal accordingly; moving the PUH along a first direction from a start point; monitoring the detection signal and stopping the PUH when the detection signal changes; moving the PUH along a second direction; monitoring the detection signal and stopping the PUH in the boundary area of the first area when the detection signal changes; and reading the information recorded in the boundary area of the first area by the PUH.

### BACKGROUND

The present invention relates to reading information recorded in a boundary area on an optical disc, and more particularly, to method and device for reading information recorded in a boundary area adjacent to a boundary between a first area (e.g. a recorded area) and a second area (e.g. an unrecorded area) on an optical disc.

For an optical disc, information relating to user data, such as a table of contents (TOC), is usually stored in a lead-in zone for further retrieval before an optical disc drive can read data on the optical disc. However, for an unfinalized optical disc, the related information of the final recorded data zone, such as the final address, is not available in the lead-in zone of the optical disc. Instead, the related information is recorded at the end of the last session near the boundary between the recorded area and the unrecorded area, i.e. the blank area. Therefore, when an optical disc drive is utilized to read all data on an unfinalized optical disc, a pick-up head (PUH), the main component for reading the optical disc, of the optical disc drive has to be properly located near the boundary between the recorded area and the unrecorded area on the unfinalized optical disc for retrieving the related information of the final recorded data zone. Otherwise, the optical disc drive's read operation will fail.

Currently, there are two kinds of optical disc drive for accessing an optical disc: optical disc recording devices and read-only optical disc drives. An optical disc recording device's capability to locate its PUH at any position in all areas including the blank area on an optical disc is well known. Thus, an optical disc recording device is able to read data stored on an unfinalized optical disc. According to the related art, however, there is no effective way for a read-only optical disc drive to locate its PUH near the boundary as described above, and this is primarily because the tracking function provided by a servo system in the read-only optical disc drive fails to operate correctly in the unrecorded area with no data stored thereon. Thus, a conventional read-only optical disc drive's read operation for an unfinalized optical disc will fail.

### SUMMARY

According to one embodiment of the present invention, a method for reading information recorded in a boundary area adjacent to a boundary between a first area and a second area on an optical disc is provided. The method comprises: controlling a pick-up head (PUH) to detect the optical disc to generate a detection signal accordingly; moving the PUH along a first direction from a start point; monitoring the detection signal and stopping the PUH when the detection signal changes; moving the PUH along a second direction; monitoring the detection signal and stopping the PUH in the boundary area of the first area when the detection signal changes; and reading the information recorded in the boundary area of the first area by the PUH.

According to another embodiment of the present invention, an optical disc information reproduction device for reading information recorded in a boundary area adjacent to a boundary between a first area and a second area on an optical disc is provided. The device comprises: a pick-up head (PUH); a moving mechanism, connected to the PUH and the optical disc; and a control circuit, electrically coupled to the PUH and the moving mechanism; wherein the control circuit controls the PUH to detect the optical disc to generate a detection signal accordingly, then, the control circuit controls the moving mechanism to move the PUH along a first direction from a start point, monitors the detection signal, and controls the moving mechanism to stop the PUH when the detection signal changes, further, the control circuit controls the moving mechanism to move the PUH along a second direction, monitors the detection signal and controls the moving mechanism to stop the PUH in the boundary area of the first area when the detection signal changes, and further the control circuit controls the PUH to read the information recorded in the boundary area of the first area.

These and other objectives of the present invention will no doubt become obvious to those skilled in the art after reading the following detailed description of the preferred embodiment that is illustrated in the various figures and drawings.

### BRIEF DESCRIPTION OF THE DRAWINGS

FIG. 1 is a block diagram illustrating an optical disc information reproduction device according to an embodiment of the present invention.

FIG. 2 is a schematic diagram illustrating data structures of an optical disc shown in FIG. 1.

FIG. 3 is a flowchart of a method for locating a pick-up head (PUH) at a target position near a boundary between a first area and a second area on an optical disc according to one embodiment of the present invention.

FIG. 4 is a diagram illustrating a relationship between a location of a PUH and a magnitude of a detection signal monitored by a control circuit.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

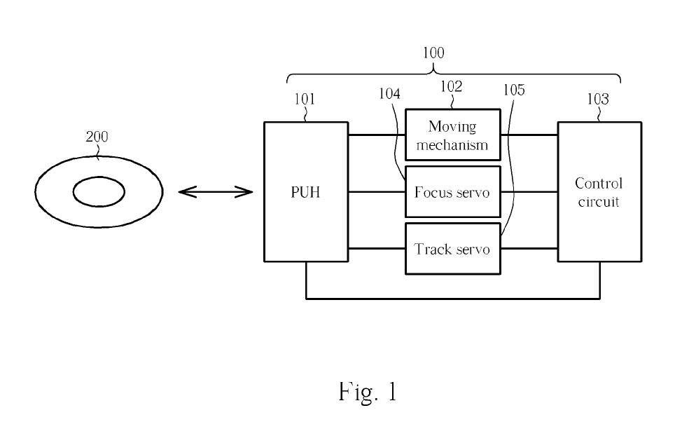

FIG. 1 is a block diagram illustrating an optical disc information reproduction device 100 according to an embodiment of the present invention. In this embodiment, the optical disc information reproduction device 100 is a read-only optical disc drive utilized to access an optical disc 200. Specifically, the optical disc information reproduction device 100 is a digital versatile disc (DVD) player commonly used in a home video system.

As shown in FIG. 1, the optical disc information reproduction device 100 comprises a pick-up head (PUH) 101, a moving mechanism 102, a control circuit 103, a focus servo 104, and a track servo 105. Please note that the optical disc information reproduction device 100 has more components, but only the components related to the present invention, as described below, are shown in FIG. 1.

The PUH 101 is utilized to access data stored on the optical disc 200 by emitting a laser beam onto the surface (i.e. a data recording layer) of the optical disc 200 and analyzing the returned laser beam reflected by the surface (i.e. a data recording layer) of the optical disc 200. The moving mechanism 102 is mechanically connected to the PUH 101 and the optical disc 200 and utilized to move the PUH 101 to any desired and possible location. The moving mechanism 102 comprises a spindle motor and a sled motor. The spindle motor is used for rotating the optical disk 200, while the sled motor is for moving the PUH 101 along a radial direction. By the cooperation of the spindle motor and the sled motor, the PUH can access the whole information recorded on the optical disc 200. The control circuit 103 is electrically coupled to, and thus controls, the PUH 101 and the moving mechanism 102. The focus servo 104 and the track servo 105 are both electrically coupled to the PUH 101 and the control circuit 103 for performing focusing control and tracking control of the PUH 101 respectively.

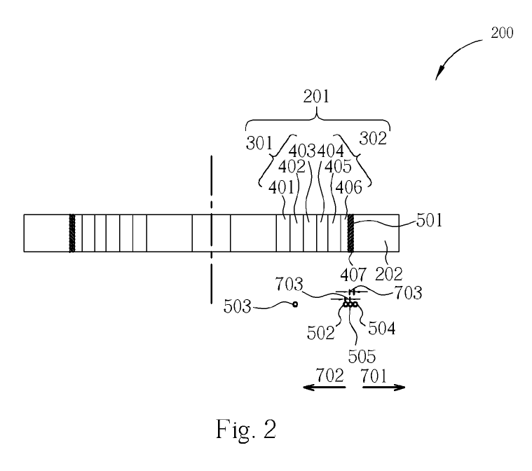

FIG. 2 is a schematic diagram illustrating data structures of the optical disc 200 shown in FIG. 1. In this embodiment, the shown optical disc 200 is an unfinalized multi-session recordable DVD based on a DVD+R specification. However, this is not meant to be a limitation of the present invention. In other words, the optical disc 200 can also be an optical disc of other types, such as a recordable compact disc (CD) based on a CD+R specification, or a recordable DVD based on a DVD-R specification. Further, in other embodiments, the optical disc 200 can also be a rewritable DVD or a rewritable CD.

As shown in FIG. 2, the optical disc 200 has a first area 201 and a second area 202 thereon. In this embodiment, the first area 201 is a recorded area with data pre-recorded thereon, and the second area 202 is an unrecorded area with no data stored thereon, i.e. a blank area. After previously recording according to the multi-session specification, the first area 201 contains a first session 301 and a second session 302. The first session 301 contains a lead-in zone 401, a first data zone 402, and a first closure zone 403. The second session 302 contains an intro zone 404, a second data zone 405, and a second closure zone 406. The second closure zone 406 comprises a reserve space allocation table (RSAT) area 407.

As shown in FIG. 2, the RSAT area 407 is adjacent to a boundary 501 between the first area 201 and the second area 202 and thus is referred to as a boundary area in this embodiment. The RSAT area 407 contains related information of the second data zone 405. The related information, such as start addresses, final addresses, and data formats, is critical to retrieving data stored in the second data zone 405.

Please note that if the optical disc 200 is finalized, the second closure zone 406 will be replaced with a lead-out zone, and the related information of the second data zone 405 will be moved to the lead-in zone 401 for further use. In this embodiment, however, the optical disc 200 is unfinalized, so there exists no information related to the second data zone 405 in the lead-in zone 401.

According to the related art, a typical read-only optical disc drive relies on the information stored in the lead-in zone to read data from the optical disc. In other words, when a conventional read-only optical disc drive attempts to access an unfinalized optical disc, such as the optical disc 200 described above, this optical disc drive will fail and no read operation can be performed, due to the lack of complete information related to all data stored on the optical disc. To solve the above-mentioned problem, the present invention discloses a method applicable for retrieving the related information of the second data zone 405 from the boundary area, i.e. the RSAT area 407. Additionally, there exists at least one copy of RSAT in the RSAT area 407.

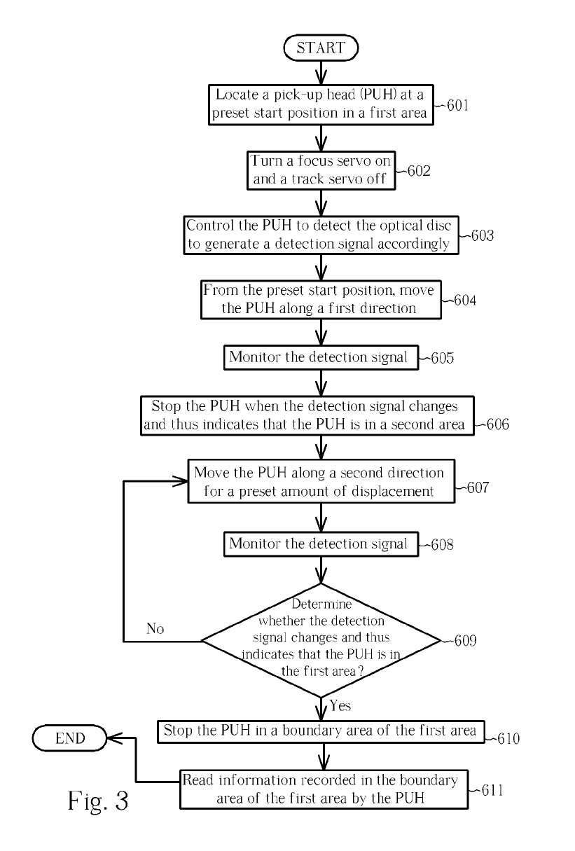

FIG. 3 is a flowchart of a method for reading information recorded in the boundary area, i.e. the RSAT area 407, adjacent to the boundary 501 between the first area 201 and the second area 202 on the optical disc 200 according to one embodiment of the present invention. As shown in FIG. 3, the method comprises the following steps:
STEP 601: Locate a pick-up head (PUH) at a start point in a first area;
STEP 602: Turn a focus servo on and a track servo off;
STEP 603: Control the PUH to detect the optical disc to generate a detection signal accordingly;
STEP 604: From the start point, move the PUH along a first direction;
STEP 605: Monitor the detection signal;
STEP 606: Stop the PUH when the detection signal changes and thus indicates that the PUH is in a second area;
STEP 607: Move the PUH along a second direction for a preset amount of displacement;
STEP 608: Monitor the detection signal;
STEP 609: Determine whether the detection signal changes and thus indicates that the PUH is in the first area. If so, proceed to STEP 610; otherwise, return to STEP 607;
STEP 610: Stop the PUH in a boundary area of the first area;
STEP 611: Read information recorded in the boundary area of the first area by the PUH.

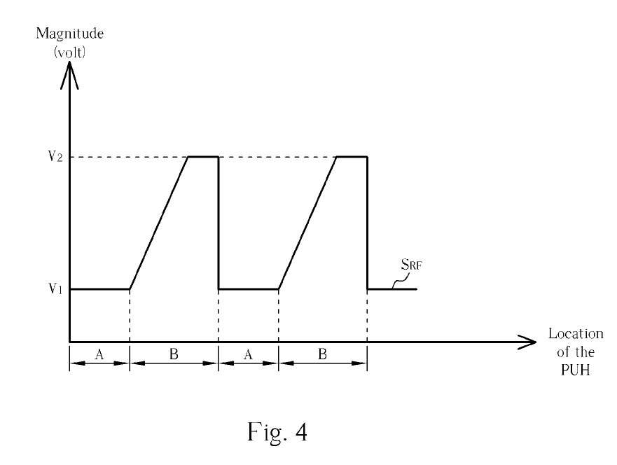

FIG. 4 is a diagram illustrating a relationship between a location of the PUH 101 and a magnitude of a detection signal S_{RF} monitored by the control circuit 103. Please note that the curve in FIG. 4 is used herein to explain the relationship but does not represent the real results produced by the above method of the present invention. Please refer to FIG. 4. Experimentally, when the PUH 101 is located in a recorded area A with data prerecorded thereon, the magnitude of the monitored detection signal S_{RF} is approximate to a first preset value V₁. When the PUH 101 is located in an unrecorded area B with no data stored thereon, i.e. a blank area, the magnitude of the monitored detection signal S_{RF} is approximate to a second preset value V₂ greater than the first preset value V₁. Based on the above experimental results, the magnitude of the monitored detection signal S_{RF} can be utilized as an indication of the position of the PUH 101. In this embodiment, the detection signal S_{RF} is a radio frequency (RF) signal indicating the current area where the PUH is located. However, with appropriate modifications to the first preset value and the second preset value, any signal generated from processing the read-back RF signal and maintaining the signal magnitude characteristic as shown in FIG. 4 can be utilized instead. Further, the detection signal in other embodiments can be other type of signals and is not limited to RF signals. These alternative designs fall in the scope of the present invention.

The detailed description as to how the optical disc information reproduction device 100 applies the above-mentioned method to read information recorded in the boundary area, i.e. the RSAT area 407, adjacent to the boundary 501 between the first area 201 and the second area 202 on the optical disc 200 is as follows. Please refer to FIGS. 1-4.

First, the control circuit 103 controls the moving mechanism 102 to locate the PUH 101 at a start point 503 in the first data zone 402 of the first area 201, i.e. the recorded area (STEP 601). Please note that, in other embodiments, it is possible for the start point 503 to be located in other areas, such as the second data zone 405. Additionally, in STEP 601, the optical disc 200 is rotated at an appropriate constant speed. Then, the control circuit 103 turns the focus servo 104 on and the track servo 105 off (STEP 602). The control circuit 103 controls the PUH 101 to detect the optical disc 200 to generate a detection signal S_{RF} accordingly (STEP 603).

Further, from the start point 503, the control circuit 103 controls the moving mechanism 102 to move the PUH 101 in a preset speed along a first direction 701 shown in FIG. 2, which is radially outward from the center of the optical disc 200 in this embodiment (STEP 604). In the meantime, the focus servo 104 remains on and the track servo 105 remains off. Then, the control circuit 103 continuously monitors the detection signal S_{RF} (STEP 605). When the magnitude of the monitored detection signal S_{RF} changes from V₁ to V₂ and thus indicates that the PUH is currently in the second area 202, i.e. the unrecorded area,, the control circuit 103 forces the moving mechanism 102 to stop the PUH 101 (STEP 606). In this embodiment, the PUH 101 is currently located at a point 504 in the second area 202, i.e. the unrecorded area.

Further, the control circuit 103 controls the moving mechanism 102 to move the PUH 101 in the preset speed along a second direction 702 shown in FIG. 2, for a preset amount of displacement 703 (STEP 607). The PUH 101 is thus moved from the point 504 to a point 505. In the meantime, the focus servo 104 remains on and the track servo 105 remains off. In this embodiment, the second direction 702 is radially inward to the center of the optical disc 200. Please note that the first direction 701 and the second direction 702 are not required to be radial in other embodiments. Moreover, the moving mechanism 102 may comprise a micro stepping motor for precisely controlling the movement of the PUH 101.

Further, the control circuit 103 continuously monitors the detection signal S_{RF} (STEP 608). Then, the control circuit 103 determines whether the magnitude of the monitored detection signal S_{RF} changes from V₂ to V₁ and thus indicates that the PUH is currently in the first area 201, i.e. the recorded area (STEP 609). In this embodiment, the magnitude of the monitored detection signal S_{RF} has not changed, so the process returns to STEP 607.

Thus, the control circuit 103 controls the moving mechanism 102 to further move the PUH 101 in the preset speed along the second direction 702 for the preset amount of displacement 703 (STEP 607). The PUH 101 is thus moved from the point 505 to a point 502. In the meantime, the focus servo 104 remains on and the track servo 105 remains off.

Further, the control circuit 103 continuously monitors the detection signal S_{RF} (STEP 608). Then, the control circuit 103 determines whether the magnitude of the monitored detection signal S_{RF} changes from V₂ to V₁ and thus indicates that the PUH is currently in the first area 201, i.e. the recorded area (STEP 609). At this present step, the magnitude of the monitored detection signal S_{RF} has changed, so the process proceeds to STEP 610.

Thus, the control circuit 103 forces the moving mechanism 102 to stop the PUH 101 in the boundary area, i.e. the RSAT area 407, of the first area 201 (STEP 610). As shown in FIG. 2, the PUH 101 is currently located at the point 502 in the boundary area, i.e. the RSAT area 407. Further, the control circuit 103 controls the PUH 101 to read the information recorded in the boundary area 407 of the first area 201. The process ends herein.

After STEP 611, the optical disc information reproduction device 100 can access all data stored in the optical disc 200 by retrieving the related information of the second data zone 405 from the RSAT area 407.

Please note that the method to detect the signal S_{RF} changing from V₂ to V₁ is not only restricted by the moving mechanism 102, but also by the lens of the PUH 101.

Please note that the method to search the RSAT area 407 can be implemented in other ways. For example, the moving mechanism 102 can start in the second data zone 405 or the second closure zone 406, then seek to the end and stop when the signal S_{RF} changes from V₁ to V₂.

Please note that the method disclosed in the above embodiment of the present invention can be implemented by hardware, i.e. circuit design, in the control circuit 103. Alternatively, the method can be implemented by software, i.e. firmware, stored in a storage accessible to the control circuit 103. The storage can be a static random access memory (SRAM) or any other kind of memory if appropriate. Additionally, the control circuit 103 can be a microprocessor used for executing the firmware to perform the above-mentioned boundary searching operation.

Please note that, in other embodiments, the first and second areas can be other types of areas according to other available optical disc specifications. For example, if the optical disc conforms to a DVD read-only specification, the first and second areas can be a lead-in zone and a data zone respectively. Then, the method and device of the present invention can be applied to locate the PUH at some point, being in the lead-in zone, near a boundary between the lead-in zone and the data zone, provided that the detection signal can distinguish the lead-in zone from the data zone.

Please note that, in other embodiments, the start point 503 can be in the second area 202, i.e. the unrecorded area. In such case, the first direction 701 and the second direction 702 are both inward to the center of the optical disc 200. Based on teachings of the present invention disclosed hereinbefore, those skilled in the art can easily realize that the disclosed boundary searching scheme, i.e. the disclosed method, can be applied to search the desired boundary no matter where the PUH is located initially.

Please note that although the optical disc information reproduction device 100 is a read-only optical disc drive, specifically a DVD player in the above preferred embodiment, it is not limited to be a read-only optical disc drive. In other embodiments the optical disc information reproduction device 100 can be an optical disc recording device, for example a DVD burner or a CD burner. The method disclosed in the above preferred embodiment of the present invention is also an effective and feasible solution for an optical disc recording device to locate its PUH near the boundary between the recorded area and the unrecorded area although there already exist well-known technologies using information with an address in pre-groove (ADIP) signal, an absolute time in pre-groove (ATIP) signal, or a pre-pit (PPIT) signal for the optical disc recording device to accomplish the same result. Moreover, in other embodiments, the optical disc information reproduction device 100 can also be an optical disc combo drive, which integrates functions of a read-only optical disc drive and an optical disc recording device in a single circuit or drive as implied by the definition of the word “combo”.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for reading information recorded in a boundary area adjacent to a boundary between a first area and a second area on an optical disc, the method comprising:
controlling a pick-up head (PUH) to detect the optical disc to generate a detection signal accordingly;
moving the PUH along a first direction from a start point;
monitoring the detection signal and stopping the PUH when the detection signal changes;
moving the PUH along a second direction;
monitoring the detection signal and stopping the PUH in the boundary area of the first area when the detection signal changes; and
reading the information recorded in the boundary area of the first area by the PUH.

2. The method of claim 1, wherein the first area is a recorded area, and the second area is an unrecorded area.

3. The method of claim 1, wherein the PUH is under a focus servo on state.

4. The method of claim 1, wherein the step of moving the PUH along the second direction comprises moving the PUH along the second direction repeatedly for a preset amount of displacement.

5. The method of claim 1, wherein the PUH is under a track servo off state before stopped in the boundary area of the first area.

6. The method of claim 1, wherein the PUH is controlled in a preset speed to move along the first direction.

7. The method of claim 1, wherein the optical disc is an unfinalized optical disc.

8. The method of claim 1, wherein the start point is in the first area, the first direction is outward from the center of the optical disc, and the second direction is inward to the center of the optical disc.

9. The method of claim 1, wherein the boundary area is in the first area.

10. The method of claim 1, wherein the start point is in the second area, and the first and second directions are both inward to the center of the optical disc.

11. The method of claim 1, wherein the detection signal is a radio frequency (RF) signal indicating the current area where the PUH is located.

12. An optical disc information reproduction device, for reading information recorded in a boundary area adjacent to a boundary between a first area and a second area on an optical disc, the device comprising:
a pick-up head (PUH);
a moving mechanism, connected to the PUH and the optical disc; and
a control circuit, electrically coupled to the PUH and the moving mechanism;
wherein the control circuit controls the PUH to detect the optical disc to generate a detection signal accordingly, then, the control circuit controls the moving mechanism to move the PUH along a first direction from a start point, monitors the detection signal, and controls the moving mechanism to stop the PUH when the detection signal changes, further, the control circuit controls the moving mechanism to move the PUH along a second direction, monitors the detection signal and controls the moving mechanism to stop the PUH in the boundary area of the first area when the detection signal changes, and further the control circuit controls the PUH to read the information recorded in the boundary area of the first area.

13. The device of claim 12, wherein the first area is a recorded area, and the second area is an unrecorded area.

14. The device of claim 12, further comprising a focus servo, electrically coupled to the PUH and the control circuit, wherein PUH is under a focus servo on state.

15. The device of claim 12, wherein the control circuit controls the moving mechanism to move the PUH along the second direction repeatedly for a preset amount of displacement.

16. The device of claim 12, further comprising a track servo, electrically coupled to the PUH and the control circuit, wherein the PUH is under a track servo off state before stopped in the boundary area of the first area.

17. The device of claim 12, wherein the PUH is controlled in a preset speed to move along the first direction.

18. The device of claim 12, wherein the optical disc is an unfinalized optical disc.

19. The device of claim 12, wherein the start point is in the first area, the first direction is outward from the center of the optical disc, and the second direction is inward to the center of the optical disc.

20. The device of claim 12, wherein the boundary area is in the first area.

21. The device of claim 12, wherein the start point is in the second area, and the first and second directions are both inward to the center of the optical disc.

22. The device of claim 12, wherein the detection signal is a radio frequency (RF) signal indicating the current area where the PUH is located.
